(19) United States
(12) Patent Application Publication
(10) Pub. No.: US 2021/0385432 A1
(43) Pub. Date: Dec. 9, 2021

(54) VEHICLE CONTROL DEVICE

(71) Applicant: LG Electronics Inc., Seoul (KR)

(72) Inventor: Minsick PARK, Seoul (KR)

(21) Appl. No.: 16/489,464

(22) PCT Filed: Mar. 15, 2019
(86) PCT No.: PCT/KR2019/003067

§ 371 Date: Aug. 28, 2019

(51) Int. Cl. H04N 17/00; G06K 9/00; G06K 9/03; H04N 5/235; G06T 7/73; B60R 1/00; G07C 5/08

(52) U.S. Cl. CPC H04N 17/002; G06K 9/00845; G06K 9/036; H04N 5/2351; H04N 5/2354; B60Q 3/00; B60R 1/00; G07C 5/0825; H04N 5/2353; G06T 2207/30268; G06T 2207/30244; G06T 7/73

(57) ABSTRACT

A vehicle control device according to an embodiment of the present invention includes an interface unit connected to a display and a camera within a vehicle; a processor receiving an image obtained by the camera through the interface unit and evaluating the received image based on a plurality of features, wherein the processor evaluates the image depending on whether the plurality of features satisfies a condition in which a driver sitting in the vehicle is recognizable; and a memory storing malfunction information of the camera corresponding to an evaluation result of the image. The processor controls the display to display malfunction information of the camera if the evaluation result of the image is determined to be poor.

### TECHNICAL FIELD

The present invention relates to a vehicle control device positioned within a vehicle.

### BACKGROUND ART

A vehicle may be classified as an internal combustion engine vehicle, an external combustion engine vehicle, a gas turbine vehicle, or an electric vehicle depending on the type of motor used.

In recent years, smart vehicles have been actively developed for the safety or convenience of drivers, pedestrians, etc., and active research is ongoing on sensors mounted on smart vehicles. Cameras, infrared sensors, radar, GPS, Lidar, gyroscopes, etc. are being used in smart vehicles, among which cameras serve to substitute for human eyes.

With the development of a variety of types of sensors and electronic equipment, a vehicle having a function for assisting a passenger's driving and improving driving safety and convenience has been in the spotlight.

In such functions, there is an increasing need for a system for monitoring a driver in order to assist or replace the driver. To verify an operation of monitoring, by a camera, a driver in real time is problematic.

### DISCLOSURE

### Technical Problem

The present invention may provide a vehicle control device provided in a vehicle.

The present invention may provide a vehicle control device for verifying the initial state of a camera after the engine of a vehicle is started.

The present invention may provide a vehicle control device for verifying the state of a camera while a vehicle is driving.

The present invention may provide a vehicle control device for outputting malfunction information when a malfunction of a camera is detected.

### Technical Solution

A vehicle control device according to at least one embodiment of the present invention is a vehicle control device detecting a malfunction of a camera photographing a driver of a vehicle. The method includes an interface unit connected to a display and a camera within a vehicle, a processor configured to receive an image obtained by the camera through the interface unit and to evaluate the received image based on a plurality of features, wherein the processor evaluates the image depending on whether the plurality of features satisfies a condition in which a driver sitting in the vehicle is recognizable, and a memory storing malfunction information of the camera corresponding to an evaluation result of the image. The processor may be configured to control the display to display malfunction information of the camera if the evaluation result of the image is determined to be poor.

The processor may be configured to control the display to display that a level of power supplied to the camera is low if an image is not received through the interface unit.

The camera may obtain one image for each exposure signal. The processor may be configured to transmit a plurality of exposure signals, corresponding to a first set value, to the camera during a unit time, and control the display to display that an exposure operation of the camera is poor if the number of images obtained from the camera during the unit time is smaller than the first set value.

The camera may photograph at least some of the body of the driver sitting in the vehicle and may include a light source providing light to the driver. The processor may be configured to select an image in which the driver is detected among a plurality of images obtained from the camera during the unit time and to control the display to display that the light source is poor if the number of selected images is smaller than a second set value.

The processor may be configured to calculate average brightness of the selected image, receive a level value of power supplied to the light source through the interface unit if the calculated average brightness is smaller than a third set value, and control the display to display that the level of the power supplied to the light source is low if the level value of the power is smaller than a fourth set value.

The processor may be configured to control the display to display that the light source of the camera is hidden if the level value of the power is greater than the fourth set value.

A plurality of the light sources may be disposed. The processor may be configured to calculate the average brightness of the selected image and to control the display to display that at least some of the plurality of light sources is hidden if the calculated average brightness is greater than a third set value.

The plurality of light sources may include a first light source provided on a first side of the camera to provide light to a first region and a second light source spaced apart from the first light source and provided on a second side of the camera to provide light to a second region. The processor may be configured to control the display to display that the second light source is hidden if the average brightness of the selected image is the third set value or more and brightness of a portion corresponding to the first region in the selected image is higher than brightness of a portion corresponding to the second region.

The camera may photograph a mark formed within the vehicle and spaced from the camera. The processor may be configured to detect a location of the mark in the image obtained by the camera, calculate an inclined angle of the camera based on the location of the mark detected in the image and the distance between the camera and the mark, and correct a viewing angle of the camera if the inclined angle is smaller than a fifth set value.

The mark may be formed in the steering wheel of the vehicle.

The processor may be configured to control the display to display that the camera is inclined if the inclined angle is the fifth set value or more.

A method of controlling a vehicle according to another embodiment of the present invention is a method of controlling a vehicle detecting a malfunction of a camera photographing a driver of a vehicle. The method may include evaluating an image obtained by the camera based on a plurality of features, wherein the image is evaluated depending on whether the plurality of features satisfies a condition in which a driver sitting in a vehicle is recognizable, determining a malfunction of the camera based on an evaluation result of the image, selecting malfunction information matched up with the evaluation result of the image if the evaluation result of the image is determined to be poor, and outputting the selected malfunction information.

The method may further include displaying, on a display positioned within the vehicle, that a level of power supplied to the camera is low if an image is not obtained by the camera.

The camera may obtain one image for each exposure signal. The method may further include transmitting, to the camera, a plurality of exposure signals corresponding to a first set value during a unit time and displaying, on the display positioned within the vehicle, that an exposure operation of the camera is poor if the number of images obtained from the camera during the unit time is smaller than the first set value.

The method may further include providing light to the driver of the vehicle through a light source positioned within the vehicle, photographing at least some of the body of the driver through the camera, selecting an image in which the driver is detected among a plurality of images obtained from the camera during the unit time, and displaying, on the display positioned within the vehicle, that the light source is poor if the number of selected images is smaller than the second set value.

The method may further include calculating average brightness of the selected image if the number of selected images is smaller than the second set value, receiving a level value of power supplied to the camera if the calculated average brightness is smaller than a third set value, and displaying, on the display positioned within the vehicle, that the level of the power supplied to the camera is low if the level value of power is smaller than a fourth set value.

The method may further include displaying, on the display positioned within the vehicle, that the light source of the camera is hidden if the level value of the power is greater than the fourth set value.

A plurality of the light sources may be disposed. The method may further include displaying, on the display positioned within the vehicle, that at least some of the plurality of light sources is hidden if the average brightness of the selected images is a third set value or more.

The method may further include photographing a mark formed within the vehicle and spaced apart from the camera at a predetermined distance through the camera, detecting a location of the mark in the image obtained by the camera and calculating an inclined angle of the camera based on the location of the mark detected in the image and the predetermined distance, and correcting a viewing angle of the camera if the inclined angle is smaller than a fifth set value.

The method may further include displaying, on the display positioned within the vehicle, that the camera is inclined if the inclined angle is the fifth set value or more.

### Advantageous Effects

According to at least one of the embodiments of the present invention, there can be provided the vehicle control device for verifying the initial state of a camera after the engine of a vehicle is started.

According to at least one of the embodiments of the present invention, there can be provided the vehicle control device for verifying the state of a camera while a vehicle is driving.

According to at least one of the embodiments of the present invention, there can be provided the vehicle control device for outputting malfunction information when a malfunction of a camera is detected.

### DESCRIPTION OF DRAWINGS

FIG. 1 shows an exterior appearance of a vehicle equipped with a vehicle control device according to an exemplary embodiment of the present invention.

FIG. 2 is an internal block diagram illustrating one example of the vehicle.

FIG. 3 is an internal block diagram illustrating one example of the vehicle control device according to an exemplary embodiment of the present invention.

FIG. 4 is an example of an internal block diagram of a monitoring system driven by a vehicle control device according to an embodiment of the present invention.

FIG. 5 shows the inside of a vehicle equipped with a vehicle control device according to an embodiment of the present invention.

FIGS. 6 to 8 are diagrams showing embodiments in which the initial state of a camera is verified after the engine of a vehicle is started.

FIGS. 9 to 14 are diagrams showing embodiments in which the state of a camera is verified while a vehicle is driving.

### MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A vehicle as described in this specification may include a car and a motorcycle. Hereinafter, a car will be as an example of a vehicle.

A vehicle as described in this specification may include all of an internal combustion engine vehicle including an engine as a power source, a hybrid vehicle including both an engine and an electric motor as a power source, and an electric vehicle including an electric motor as a power source.

In some implementations, the left of a vehicle means the left of the vehicle in the direction of travel and the right of the vehicle means the right of the vehicle in the direction of travel.

In some implementations, a left hand drive (LHD) vehicle will be assumed unless otherwise stated.

Hereinafter, a user, a driver, a passenger, and a fellow passenger may be used interchangeably depending on the embodiment.

In the following description, the vehicle control device 400 is a separate device provided in the vehicle 700, and may exchange necessary information with the vehicle 700 through data communication. The vehicle control device 400 may include at least some of the units of the vehicle 700. The vehicle control device 400 may be referred to as a control device 400, a driving assistance device 400, a vehicle driving assistance device 400, or an assistance device 400.

Alternatively, at least some of the units of the vehicle control device 400 may be a unit(s) of the vehicle 700 or of another device mounted in the vehicle 700. Such external units may be understood as being included in the vehicle control device 400 by transmitting and receiving data through an interface unit of the vehicle control device 400.

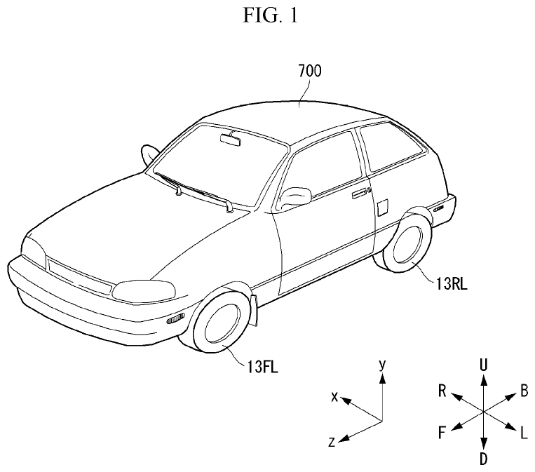

FIG. 1 shows an exterior appearance of a vehicle 700 equipped with a vehicle control device 400 according to an exemplary embodiment of the present invention. Referring to FIG. 1, the vehicle 700 may include wheels 13FL and 12RL rotating by a power source.

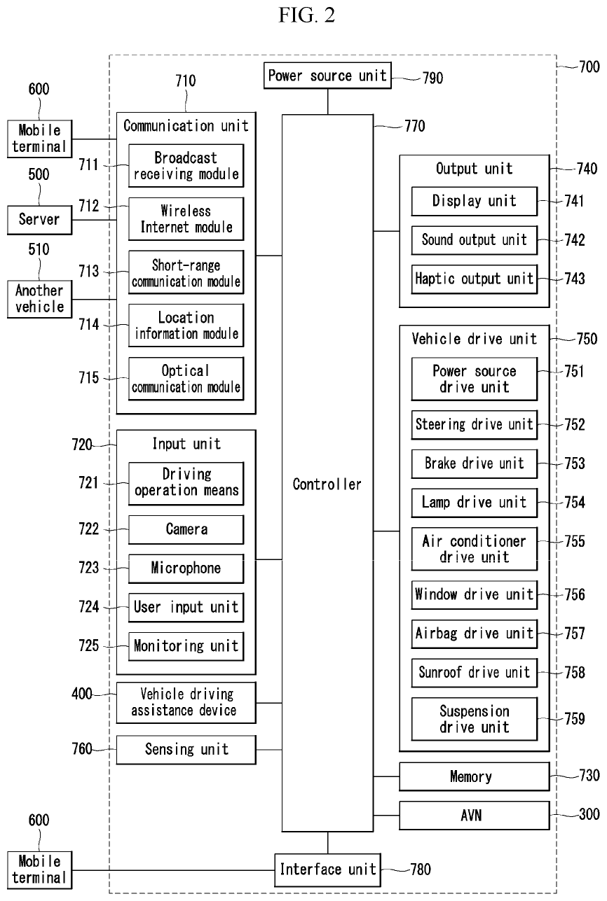

FIG. 2 is an internal block diagram illustrating one example of the vehicle 700. The vehicle may include a communication unit 710, an input unit 720, a sensing unit 760, an output unit 740, a vehicle drive unit 750, a memory 730, an interface unit 780, a controller 770, a power source unit 790, a control device 400, and an AVN apparatus 300. The communication unit 710 may include one or more modules to enable the wireless communication between the vehicle and the mobile terminal 600, between the vehicle and an external server 500, or between the vehicle and another vehicle 510. In addition, the communication unit 710 may include one or more modules to connect the vehicle to one or more networks.

The communication unit 710 may include a broadcast receiving module 711, a wireless Internet module 712, a short-range communication module 713, a location information module 714, and an optical communication module 715.

The broadcast receiving module 711 is configured to receive a broadcast signal or broadcast associated information from an external broadcast managing server via a broadcast channel. Here, broadcast includes radio broadcast or TV broadcast.

The wireless Internet module 712 is a module for wireless Internet access. The wireless Internet module 712 may be internally or externally coupled to the vehicle 700. The wireless Internet module 712 may transmit or receive wireless signals via communication networks according to wireless Internet technologies.

Examples of such wireless Internet technologies include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), High Speed Uplink Packet Access (HSUPA), Long Term Evolution (LTE), and LTE-A (Long Term Evolution-Advanced). The wireless Internet module 712 may transmit and receive data according to one or more of such wireless Internet technologies, and other Internet technologies as well. For example, the wireless Internet module 712 may exchange data with the external server 500 in a wireless manner. The wireless Internet module 712 may receive weather information and road traffic state information (e.g., Transport Protocol Expert Group (TPEG) information) from the external server 500.

The short-range communication module 713 may assist short-range communication using at least one selected from among Bluetooth™, Radio Frequency Identification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like.

The short-range communication module 713 forms wireless area networks to perform the short-range communication between the vehicle 700 and at least one external device. For example, the short-range communication module 713 may exchange data with the mobile terminal 600 in a wireless manner. The short-range communication module 713 may receive weather information and road traffic state information (e.g., Transport Protocol Expert Group (TPEG) information) from the mobile terminal 600. When the user boards the vehicle 700, the mobile terminal 600 of the user and the vehicle 700 may pair with each other automatically or as the user executes a pairing application.

The location information module 714 is a module to acquire a location of the vehicle 700. A representative example of the location information module 714 includes a Global Position System (GPS) module. For example, when the vehicle utilizes a GPS module, a location of the vehicle may be acquired using signals transmitted from GPS satellites.

The optical communication module 715 may include a light emitting unit and a light receiving unit.

The light receiving unit may convert light into electrical signals to receive information. The light receiving unit may include Photo Diodes (PDs) to receive light. The photo diodes may convert light into electrical signals. For example, the light receiving unit may receive information regarding a preceding vehicle via light emitted from a light source included in the preceding vehicle.

The light emitting unit may include at least one light emitting element to convert electrical signals into light. Here, the light emitting element may be a Light Emitting Diode (LED). The light emitting unit converts electrical signals into light to thereby emit the light. For example, the light emitting unit may externally emit light via flickering of the light emitting element corresponding to a prescribed frequency. In some embodiments, the light emitting unit may include an array of a plurality of light emitting elements. In some embodiments, the light emitting unit may be integrated with a lamp provided in the vehicle 700. For example, the light emitting unit may be at least one selected from among a headlight, a taillight, a brake light, a turn signal light, and a sidelight. For example, the optical communication module 715 may exchange data with another vehicle 510 via optical communication.

The input unit 720 may include a driving operation unit 721, a camera 722, a microphone 723, and a user input unit 724.

The driving operation unit 721 is configured to receive user input for the driving of the vehicle. The driving operation unit 721 may include a steering input unit 721a, a shift input unit 721b, an acceleration input unit 721c, and a brake input unit 721d.

The camera 722 may include an image sensor and an image processing module. The camera 722 may process a still image or a moving image acquired by the image sensor (e.g., a CMOS or a CCD). The image processing module may extract required information by processing a still image or a moving image acquired via the image sensor and, then, may transmit the extracted information to the controller 770. Meanwhile, the vehicle 700 may include the camera 722 to capture a forward image or a surround-view image of the vehicle and a monitoring unit 725 to capture an image of the interior of the vehicle.

The monitoring unit 725 may capture an image of a passenger. The monitoring unit 725 may capture an image of biometrics of the passenger.

The microphone 723 may process external sound signals into electrical data. The processed data may be utilized in various ways according to a function that the vehicle 700 is performing. The microphone 723 may convert a user voice command into electrical data. The converted electrical data may be transmitted to the controller 770.

Meanwhile, in some embodiments, the camera 722 or the microphone 723 may be components of the sensing unit 760, other than components of the input unit 720.

The user input unit 724 is configured to receive information from the user. When information is input via the user input unit 724, the controller 770 may control the operation of the vehicle 700 to correspond to the input information. The user input unit 724 may include a touch input unit or a mechanical input unit. In some embodiments, the user input unit 724 may be located in a region of the steering wheel. In this case, the driver may operate the user input unit 724 with the fingers while gripping the steering wheel.

The sensing unit 760 is configured to sense signals associated with, for example, the traveling of the vehicle 700. To this end, the sensing unit 760 may include a collision sensor, a wheel sensor, a speed sensor, gradient sensor, a weight sensor, a heading sensor, a yaw sensor, a gyro sensor, a position module, a vehicle forward/backward movement sensor, a battery sensor, a fuel sensor, a tire sensor, a steering sensor based on the rotation of a steering wheel, a vehicle interior temperature sensor, a vehicle interior humidity sensor, an ultrasonic sensor, an infrared sensor, a radar, and Lidar.

As such, the sensing unit 760 may acquire sensing signals with regard to, for example, vehicle collision information, vehicle traveling direction information, vehicle location information (GPS information), vehicle angle information, vehicle speed information, vehicle acceleration information, vehicle tilt information, vehicle forward/backward movement information, battery information, fuel information, tire information, vehicle lamp information, vehicle interior temperature information, vehicle interior humidity information, and steering wheel rotation angle information.

Meanwhile, the sensing unit 760 may further include, for example, an accelerator pedal sensor, a pressure sensor, an engine speed sensor, an Air Flow-rate Sensor (AFS), an Air Temperature Sensor (ATS), a Water Temperature Sensor (WTS), a Throttle Position Sensor (TPS), a Top Dead Center (TDC) sensor, and a Crank Angle Sensor (CAS).

The sensing unit 760 may include a biometric information sensing unit. The biometric information sensing unit is configured to sense and acquire biometric information of the passenger. The biometric information may include fingerprint information, iris-scan information, retina-scan information, hand geometry information, facial recognition information, and voice recognition information. The biometric information sensing unit may include a sensor to sense biometric information of the passenger. Here, the monitoring unit 725 and the microphone 723 may operate as sensors. The biometric information sensing unit may acquire hand geometry information and facial recognition information via the monitoring unit 725.

The output unit 740 is configured to output information processed in the controller 770. The output unit 740 may include a display unit 741, a sound output unit 742, and a haptic output unit 743.

The display unit 741 may display information processed in the controller 770. For example, the display unit 741 may display vehicle associated information. Here, the vehicle associated information may include vehicle control information for the direct control of the vehicle or driver assistance information to guide vehicle driving. In addition, the vehicle associated information may include vehicle state information that notifies a current state of the vehicle or vehicle traveling information regarding the traveling of the vehicle.

The display unit 741 may include at least one selected from among a liquid crystal display (LCD), a thin film transistor liquid-crystal display (TFT LCD), an organic light-emitting diode (OLED), a flexible display, a 3D display, and an e-ink display.

The display unit 741 may configure an inter-layer structure with a touch sensor, or may be integrally formed with the touch sensor to implement a touchscreen. The touchscreen may function as the user input unit 724 which provides an input interface between the vehicle 700 and the user and also function to provide an output interface between the vehicle 700 and the user. In this case, the display unit 741 may include a touch sensor which senses a touch to the display unit 741 so as to receive a control command in a touch manner.

When a touch is input to the display unit 741 as described above, the touch sensor may sense the touch and the controller 770 may generate a control command corresponding to the touch. Content input in a touch manner may be characters or numbers, or may be, for example, instructions in various modes or menu items that may be designated.

The touch sensor and the proximity sensor may be implemented individually, or in combination, to sense various types of touches. Such touches include a short (or tap) touch, a long touch, a multi-touch, a drag touch, a flick touch, a pinch-in touch, a pinch-out touch, a swipe touch, a hovering touch, and the like. Hereinafter, a touch or a touch input may generally refer to various types of touches mentioned above.

Meanwhile, the display unit 741 may include a cluster to allow the driver to check vehicle state information or vehicle traveling information while driving the vehicle. The cluster may be located on a dashboard. In this case, the driver may check information displayed on the cluster while looking forward.

Meanwhile, in some embodiments, the display unit 741 may be implemented as a Head Up display (HUD). When the display unit 741 is implemented as a HUD, information may be output via a transparent display provided at the windshield. Alternatively, the display unit 741 may include a projector module to output information via an image projected to the windshield.

The sound output unit 742 is configured to convert electrical signals from the controller 770 into audio signals and to output the audio signals. To this end, the sound output unit 742 may include, for example, a speaker. The sound output unit 742 may output sound corresponding to the operation of the user input unit 724.

The haptic output unit 743 is configured to generate tactile output. For example, the haptic output unit 743 may operate to vibrate a steering wheel, a safety belt, or a seat so as to allow the user to recognize an output thereof.

The vehicle drive unit 750 may control the operation of various devices of the vehicle. The vehicle drive unit 750 may include at least one of a power source drive unit 751, a steering drive unit 752, a brake drive unit 753, a lamp drive unit 754, an air conditioner drive unit 755, a window drive unit 756, an airbag drive unit 757, a sunroof drive unit 758, and a suspension drive unit 759.

The power source drive unit 751 may perform electronic control for a power source inside the vehicle 700. For example, in the case where a fossil fuel based engine (not illustrated) is a power source, the power source drive unit 751 may perform electronic control for the engine. As such, the power source drive unit 751 may control, for example, an output torque of the engine. In the case where the power source drive unit 751 is the engine, the power source drive unit 751 may control the speed of the vehicle by controlling the output torque of the engine under the control of the controller 770. In another example, when an electric motor (not illustrated) is a power source, the power source drive unit 751 may perform control for the motor. As such, the power source drive unit 751 may control, for example, the RPM and torque of the motor.

The steering drive unit 752 may include a steering apparatus. As such, the direction of travel of the vehicle may be changed.

The brake drive unit 753 may perform electronic control of a brake apparatus (not illustrated) inside the vehicle 700. For example, the brake drive unit 753 may reduce the speed of the vehicle 700 by controlling the operation of brakes located at wheels. In another example, the brake drive unit 753 may adjust the direction of travel of the vehicle 700 leftward or rightward by differentiating the operation of respective brakes located at left and right wheels.

The lamp drive unit 754 may turn at least one lamp arranged inside and outside the vehicle 700 on or off. The lamp drive unit 754 may include a lighting apparatus. In addition, the lamp drive unit 754 may control, for example, the intensity and direction of light of each lamp included in the lighting apparatus. For example, the lamp drive unit 754 may perform control for a turn signal lamp, a headlamp or a brake lamp.

The air conditioner drive unit 755 may perform the electronic control of an air conditioner (not illustrated) inside the vehicle 700. For example, when the interior temperature of the vehicle 700 is high, the air conditioner drive unit 755 may operate the air conditioner to supply cold air to the interior of the vehicle 700.

The window drive unit 756 may perform the electronic control of a window apparatus inside the vehicle 700. For example, the window drive unit 756 may control the opening or closing of left and right windows of the vehicle 700.

The airbag drive unit 757 may perform the electronic control of an airbag apparatus inside the vehicle 700. For example, the airbag drive unit 757 may control an airbag to be deployed in a dangerous situation.

The sunroof drive unit 758 may perform electronic control of a sunroof apparatus inside the vehicle 700. For example, the sunroof drive unit 758 may control the opening or closing of a sunroof.

The suspension drive unit 759 may perform electronic control on a suspension apparatus (not shown) inside the vehicle 700. For example, when the road surface is uneven, the suspension drive unit 759 may control the suspension apparatus to reduce vibration of the vehicle 700.

The memory 730 is electrically connected to the controller 770. The memory 730 may store basic data for each unit, control data for the operation control of the unit, and input/output data. The memory 730 may be various hardware storage devices such as, for example, a ROM, a RAM, an EPROM, a flash drive, and a hard drive. The memory 730 may store various data for the overall operation of the vehicle 700 such as, for example programs for the processing or control of the controller 770.

The interface unit 780 may serve as a passage for various kinds of external devices that are connected to the vehicle 700. For example, the interface unit 780 may have a port that is connectable to the mobile terminal 600 and may be connected to the mobile terminal 600 via the port. In this case, the interface unit 780 may exchange data with the mobile terminal 600.

Meanwhile, the interface unit 780 may serve as a passage for the supply of electrical energy to the connected mobile terminal 600. When the mobile terminal 600 is electrically connected to the interface unit 780, the interface unit 780 supplies electrical energy from the power source unit 790 to the mobile terminal 600 under the control of the controller 770.

The controller 770 may control the overall operation of each unit inside the vehicle 700. The controller 770 may be referred to as an Electronic Control Unit (ECU).

The controller 770 may execute a function corresponding to an execution signal delivered from the control device 100.

The controller 770 may be implemented in a hardware manner using at least one selected from among Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electric units for the implementation of other functions.

The power source unit 790 may supply power required to operate the respective components under the control of the controller 770. In particular, the power source unit 790 may receive power from, for example, a battery (not illustrated) inside the vehicle 700.

The AVN apparatus 300 may exchange data with the controller 770. The controller 770 may receive navigation information from the AVN apparatus 300 or a separate navigation apparatus (not illustrated). Here, the navigation information may include set destination information, destination based routing information, and map information or vehicle location information related to vehicle traveling.

The vehicle control device 400 may be understood as included in the vehicle 700.

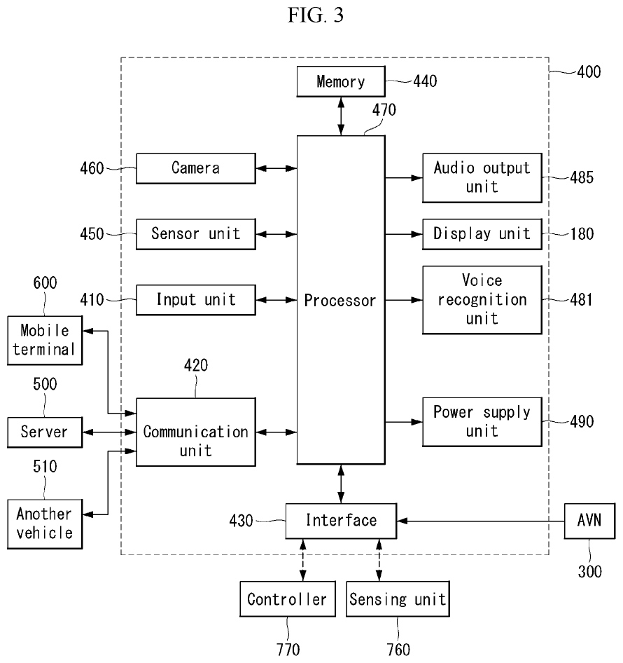

FIG. 3 is an internal block diagram illustrating one example of the vehicle control device 400 according to an exemplary embodiment of the present invention. Referring to FIG. 3, the vehicle control device 400 may include an input unit 410, a communication unit 420, an interface 430, a memory 440 a camera 460, a sensor unit 450, a processor 470, an audio output unit 485, and a power supply unit 490. The vehicle control device 400 may include additional components in addition to the above-described components, or some of the above-described components may be omitted. Here, units of the same names, among the units included in the vehicle control device 400 and the units included in the vehicle 700 may be included in the vehicle 700 or the vehicle control device 400.

The vehicle control device 400 may include the input unit 410 for receiving user input. For example, a user may input settings for a sliding function provided by the vehicle control device 400 through the input unit 410, or may input execution of power on/off of the vehicle control device 400.

The input unit 410 may include at least one of a gesture input unit (e.g., an optical sensor, etc.) for sensing a user gesture, a touch input unit (e.g., a touch sensor, a touch key, a push key (mechanical key), etc.) for sensing touch, and a microphone for sensing voice input and receive user input.

Next, the vehicle control device 400 may include the communication unit 420 for communicating with another vehicle 510, a terminal 600 and a server 500. The communication unit 420 may be referred to as a wireless communication unit 420.

The vehicle control device 400 may receive communication information including at least one of navigation information, another vehicle 510's traveling information, and traffic information through the communication unit 420. The vehicle control device 400 may send information about the vehicle 700 through the communication unit 420.

The communication unit 420 may receive at least one of position information, weather information and road traffic condition information (e.g., transport protocol experts group (TPEG), etc.) from the mobile terminal 600 and/or the server 500.

The communication unit 420 may receive traffic information from the server 500 having an intelligent traffic system (ITS). Here, the traffic information may include traffic signal information, lane information, vehicle surrounding information or position information.

In addition, the communication unit 420 may receive navigation information from the server 500 and/or the mobile terminal 600. Here, the navigation information may include at least one of map information related to vehicle driving, lane information, vehicle position information, set destination information and route information according to the destination.

For example, the communication unit 420 may receive the real-time position of the vehicle as the navigation information. In detail, the communication unit 420 may include a global positioning system (GPS) module and/or a Wi-Fi (Wireless Fidelity) module and acquire the position of the vehicle.

In addition, the communication unit 420 may receive driving information of another vehicle 510 from the another vehicle 510 and transmit information on this vehicle, thereby sharing driving information between vehicles. Here, the shared driving information may include vehicle traveling direction information, position information, vehicle speed information, acceleration information, moving route information, forward/reverse information, adjacent vehicle information and turn signal information.

In addition, when a user rides in the vehicle, the mobile terminal 600 of the user and the vehicle control device 400 may pair with each other automatically or by executing a user application.

The communication unit 420 may exchange data with the another vehicle 510, the mobile terminal 600 or the server 500 in a wireless manner. The communication unit 420 may perform wireless communication using a wireless data communication method. As the wireless data communication method, technical standards or communication methods for mobile communications (for example, Global System for Mobile Communication (GSM), Code Division Multiple Access (CDMA), CDMA2000 (Code Division Multiple Access 2000), EV-DO (Evolution-Data Optimized), Wideband CDMA (WCDMA), High Speed Downlink Packet Access (HSDPA), HSUPA (High Speed Uplink Packet Access), Long Term Evolution (LTE), LTE-A (Long Term Evolution-Advanced), and the like) may be used.

The communication unit 420 is configured to facilitate wireless Internet technology. Examples of such wireless Internet technology include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like.

The communication unit 420 is configured to facilitate short-range communication. For example, short-range communication may be supported using at least one of Bluetooth™ Radio Frequency Identification (RFID), Infrared Data Association (IrDA), Ultra-Wideband (UWB), ZigBee, Near Field Communication (NFC), Wireless-Fidelity (Wi-Fi), Wi-Fi Direct, Wireless USB (Wireless Universal Serial Bus), and the like.

In addition, the vehicle control device 400 may pair with the mobile terminal located inside the vehicle using a short-range communication method and wirelessly exchange data with the other vehicle 510 or the server 500 using a long-distance wireless communication module of the mobile terminal.

Next, the vehicle control device 400 may include the interface 430 for receiving data of the vehicle 700 and transmitting a signal processed or generated by the processor 470.

The vehicle control device 400 may receive at least one of driving information of another vehicle, navigation information and sensor information via the interface 430.

To this end, the interface 430 may perform data communication with at least one of the controller 770 of the vehicle, an audio-video-navigation (AVN) apparatus 300, and the sensing unit 760 using a wired or wireless communication method. The interface 430 may receive navigation information by data communication with the controller 770, the AVN apparatus 300 and/or a separate navigation apparatus. In addition, the interface 430 may receive sensor information from the controller 770 or the sensing unit 760.

Here, the sensor information may include at least one of vehicle traveling direction information, vehicle position information, vehicle speed information, acceleration information, vehicle tilt information, forward/reverse information, fuel information, information on a distance from a preceding/rear vehicle, information on a distance between a vehicle and a lane and turn signal information, etc.

The sensor information may be acquired from a heading sensor, a yaw sensor, a gyro sensor, a position module, a vehicle forward/reverse sensor, a wheel sensor, a vehicle speed sensor, a vehicle tilt sensor, a battery sensor, a fuel sensor, a tire sensor, a steering sensor using handle rotation, a vehicle inside temperature sensor, a vehicle inside humidity sensor, a door sensor, etc. The position module may include a GPS module for receiving GPS information.

The interface 430 may receive user input via the user input unit 410 of the vehicle. The interface 430 may receive user input from the input unit of the vehicle or via the controller 770. That is, when the input unit is provided in the vehicle, user input may be received via the interface 430.

In addition, the interface 430 may receive traffic information acquired from the server. The server 500 may be located at a traffic control surveillance center for controlling traffic. For example, when traffic information is received from the server 500 via the communication unit 420 of the vehicle, the interface 430 may receive traffic information from the controller 770.

Next, the memory 440 may store a variety of data for overall operation of the vehicle control device 400, such as a program for processing or control of the processor 470.

In addition, the memory 440 may store data and commands for operation of the vehicle control device 400 and a plurality of application programs or applications executed in the vehicle control device 400. At least some of such application programs may be downloaded from an external server through wireless communication. At least some of such application programs may be installed in the vehicle control device 400 upon release. Such application programs may be stored in the memory 440, and may be executed to perform operation (or function) of the vehicle control device 400 by the processor 470.

The memory 440 may store data for checking an object included in an image. For example, the memory 440 may store data for checking a predetermined object using a predetermined algorithm when the predetermined object is detected from an image of the vicinity of the vehicle acquired through the camera 460. For example, the memory 440 may store data for checking a predetermined object such as a passenger, garbage, or a lost item from an image acquired through the camera 460.

The memory 440 may be implemented in a hardware manner using at least one selected from among a flash memory, a hard disk, a solid state drive (SSD), a silicon disk drive (SDD), a micro multimedia card, a card type memory (e.g., an SD or XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk and an optical disc.

In addition, the vehicle control device 400 may operate in association with a web storage for performing a storage function of the memory 440 over the Internet.

The sensor unit 450 may acquire information on the internal state of the vehicle 700. The sensor unit 450 may sense an object or thing within the vehicle 700. Alternatively, the camera 460 may capture a passenger in the vehicle 700.

The camera 460 may capture the inside of the vehicle 700. The camera 460 may capture the surroundings of the vehicle control device 400. Alternatively, the camera 460 may capture the surroundings of a seat where the vehicle control device 400 is installed. Alternatively, the camera 460 may capture a passenger in the seat.

A display unit 180 may commonly refer to a display device installed inside the vehicle. The display unit 180 may be referred to as a display 180 or a display device 180. The processor 470 may be referred to as a control unit 470 or a controller 470. The processor 470 may detect an object in the vicinity of the vehicle control device 400 through the camera 460. Alternatively, the processor 470 may detect a passenger, the passenger's gaze, or the passenger's movement through the camera 460. The processor 470 may control a voice recognition unit 481.

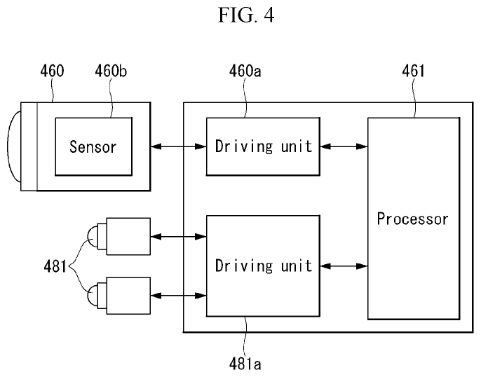

FIG. 4 is an example of an internal block diagram of a monitoring system driven by the vehicle control device 400 according to an embodiment of the present invention. The camera 460 may include a sensor 460b. The sensor 460b may be a sensor 460b obtaining or capturing an image. A driving unit 460a may be an electronic device driving the camera 460. For example, the driving unit 460a may be a printed circuit board (PCB) or a chip. A driving unit 481a may be an electronic device driving a light source 481. For example, the driving unit 481a may be a PCB or a chip. A processor 461 may be connected to the driving units 460a and 481a. The processor 461 may transmit an exposure signal to the camera 460 through the driving unit 481a. The camera 460 may obtain or capture an image in response to an exposure signal.

The light source 481 may provide light toward a driver 900 or a driver's seat S1. The light source 481 may provide infrared light.

The driving unit 460a, 481a may be understood as being part of the processor 461. The processor 461 may be understood as being part of the processor 470 of the vehicle control device 400. Alternatively, the driving unit 460a, 481a and the processor 461 may be understood as being part of the processor 470 of the vehicle control device 400. Alternatively, the driving unit 460a may be understood as being included in the camera 460. Alternatively, the driving unit 481a may be understood as being included in the light source 481.

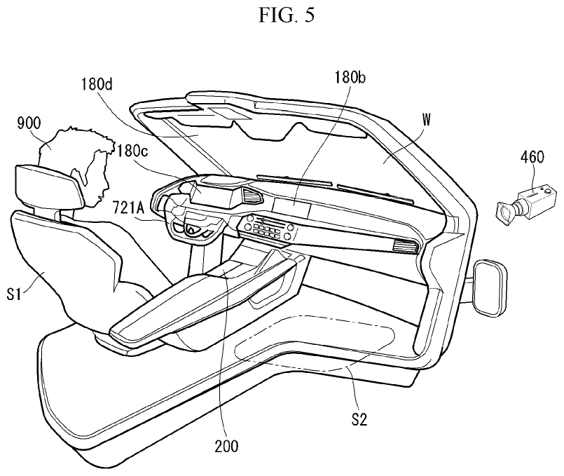

FIG. 5 shows the inside of the vehicle 700 equipped with the vehicle control device 400 according to an embodiment of the present invention. Referring to FIG. 5, the camera may be positioned within the vehicle 700. The camera may photograph the internal space of the vehicle 700. The camera 460 may photograph the driver's seat. Alternatively, the camera 460 may photograph the driver 900 who sits in the driver's seat S1. Alternatively, the camera 460 may photograph the surroundings of the driver's seat S1, the surroundings of a control board 200, and the surroundings of a fellow passenger's seat S2. The camera 460 may obtain an image of the driver 900 at given time intervals.

The control board 200 may be positioned within the vehicle 700. The control board 200 may be positioned on one side of the driver's seat S1. Alternatively, the control board 200 may be positioned between the driver's seat S1 and the fellow passenger's seat S2. The control board 200 may be called a control board 200, a center console 200 or a console 200.

A display 180 may include at least one of a liquid crystal display (LCD), a thin film transistor-liquid crystal display (TFT LCD), an organic light-emitting diode (OLED), a flexible display, a 3D display, or an e-ink display. The display 180 may be called a display unit 180.

The display 180 may implement a touch screen by forming a mutual layer structure along with a touch sensor or being integrated with a touch senor. Such a touch screen may function as a user input unit 724 providing an input interface between the vehicle 700 and a user, and may also provide an output interface between the vehicle 700 and a user. In this case, the display 180 may include a touch sensor for detecting a touch on the display 180 so that it can receive a control command according to a touch method.

When a touch on the display 180 is performed, the touch sensor may detect the touch. The processor 470 may execute a control command, corresponding to the touch, based on the detection of the touch. Contents input by a touch method may be text or a number or may be a menu item which may be indicated or designated in a variety of types of modes.

The display 180 may generally refer to a cluster 180c, a center display 180b, and a head-up display 180d positioned in the front window W of the vehicle 700, within the vehicle 700.

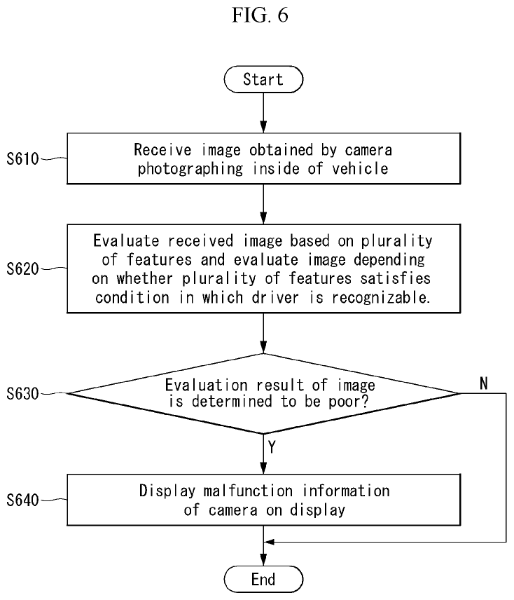

FIGS. 6 to 8 are diagrams showing embodiments in which the initial state of a camera is verified after the engine of a vehicle is started.

Referring to FIG. 6, the processor 470 may receive an image obtained by the camera 460 that photographs the inside of the vehicle 700. The camera 460 may photograph the driver's seat. Alternatively, the camera 460 may photograph the driver 900 who sits in the driver's seat S1. The camera 460 may obtain an image of the driver 900 at given time intervals (S610).

The processor 470 may evaluate the received image based on a plurality of features. The processor 470 may evaluate the image depending on whether the plurality of features satisfies the condition in which the driver 900 can be recognized (S620). The plurality of features for evaluating an image is described later. The condition in which the driver 900 can be recognized based on the plurality of features is described later.

The processor 470 may determine whether an evaluation result of the image is poor (S630). If the condition is not satisfied, the processor 470 may determine the evaluation result of the image to be poor.

If the evaluation result of the image is determined to be poor, malfunction information of the camera 460 may be displayed on the display 180 (S640). The malfunction information displayed on the display 180 may include text or an image that provides notification of a malfunction cause of the camera 460 or text or an image that shows a handling method to the driver 900. The malfunction information may be output in a sound form through the audio output unit 485.

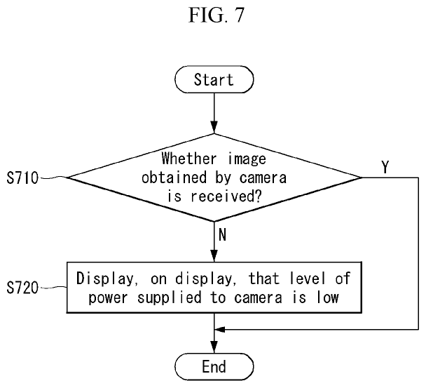

Referring to FIG. 7, the processor 470 may determine whether an image obtained by the camera 460 is received (S710). A plurality of features may include whether an image obtained by the camera 460 is received. In this case, a condition may include whether the image is received. If the image obtained by the camera 460 is not received, the processor 470 may determine an evaluation result of an image to be poor.

If the image obtained by the camera 460 is not received, the processor 470 may display, on the display 180, that a level of power supplied to the camera 460 is low in a text or image form (S720). Alternatively, the processor may output that the level of the power is low in a sound form. Alternatively, the processor 470 may output notification, indicating that the driver 900 should check a power connection. What the level of power is low may include a meaning that a voltage value supplied to the camera 460 is low or a current value supplied to the camera 460 is low. Alternatively, the processor 470 may turn on or display a warning light.

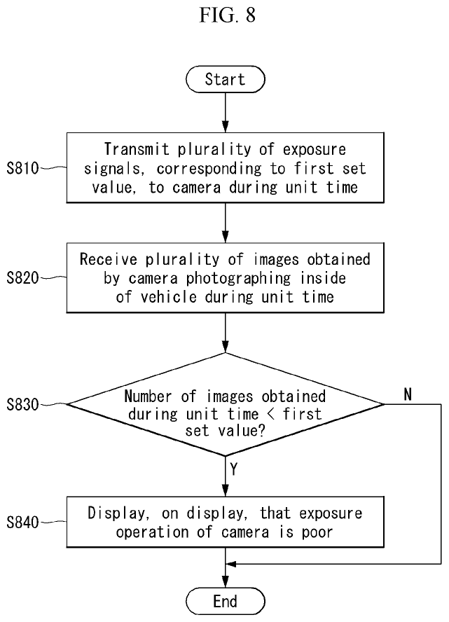

Referring to FIG. 8, the processor 470 may transmit a plurality of exposure signals, corresponding to a first set value, to the camera 460 during a unit time (S810). When an exposure signal is received, the camera 460 may obtain or capture one image. The first set value may be an integer. For example, the unit time may be 1 second, and the first set value may be 60.

The processor 470 may receive a plurality of images obtained by the camera 460 during the unit time (S820). For example, the processor 470 may receive a plurality of images obtained by the camera 460 during 1 second.

The processor 470 may determine whether the number of images received from the camera 460 during a unit time is smaller than a first set value (S830). A plurality of features may include that the processor 470 transmits an exposure signal to the camera 460 and calculates the number of images obtained from the camera 460. In this case, a condition may include that the processor 470 transmits a plurality of the exposure signals as much as the first set value and whether the number of received images is smaller than the first set value. If the number of images obtained by the camera 460 is smaller than the first set value, the processor 470 may determine that an evaluation result of the image is poor.

If the number of images obtained by the camera 460 is smaller than the first set value, the processor 470 may display, on the display 180, that the exposure operation of the camera 460 is poor in a text or image form (S840). Alternatively, the processor 470 may output that the exposure operation of the camera 460 is poor in a sound form. Alternatively, the processor 470 may output notification, indicating that the driver 900 needs a service check. Alternatively, the processor 470 may turn on or display a warning light.

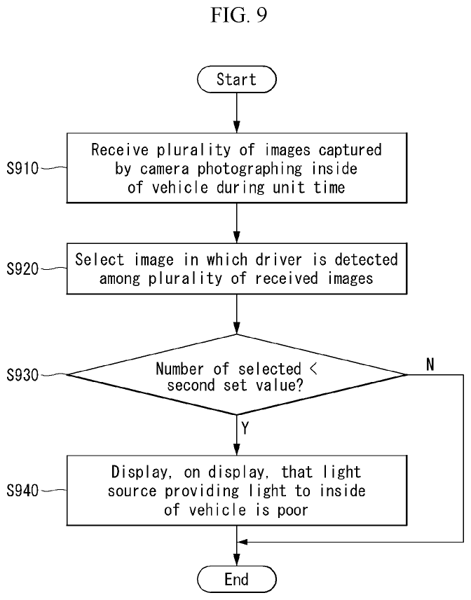

FIGS. 9 to 14 are diagrams showing embodiments in which the state of the camera 460 is verified while the vehicle 700 is driving.

Referring to FIG. 9, the processor 470 may receive a plurality of images captured by the camera 460 during a unit time (S910). For example, the unit time may be 5 seconds, and the plurality of images may be 300 in number.

The processor 470 may select an image in which the driver 900 is detected among the plurality of received images (S920). The meaning that the driver 900 is detected may include a case where the processor 470 can recognize the driver 900 in an image. For example, the processor 470 may recognize the driver 900 by recognizing the face of the driver 900 or at least some of the body of the driver 900 in an image.

The processor 470 may count the number of images in which the driver 900 is detected among the plurality of received images. The processor 470 may determine whether the number of images in which the driver 900 is detected is smaller than a second set value (S930). The second set value may be an integer equal to or smaller than the number of images received from the camera 460 during a unit time. For example, if the unit time is 5 seconds, the second set value may be 150. A plurality of features may include that the processor 470 receives a plurality of images from the camera 460, selects an image in which the driver 900 is detected among the received images, and counts the number of selected images. In this case, a condition may include whether the number of images in which the driver 900 is detected is smaller than the second set value. If the number of images in which the driver 900 is detected is smaller than the second set value, the processor 470 may determine an evaluation result of an image to be poor.

If the number of images in which the driver 900 is detected is smaller than the second set value, the processor 470 may display, on the display 180, that the light source 481 is poor in a text or image form (S940). Alternatively, the processor may output that the light source 481 is poor in a sound form. Alternatively, the processor 470 may output notification, indicating that the driver 900 needs a service check. Alternatively, the processor 470 may turn on or display a warning light.

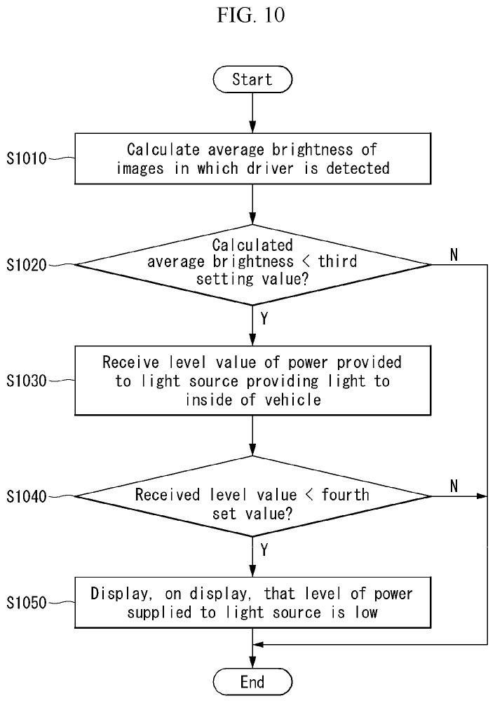

Referring to FIG. 10, the processor 470 may calculate average brightness of images in which the driver 900 is detected (S1010). For example, average brightness of one image may be a value obtained by dividing the sum of brightness of all the pixels of the image by a value obtained by multiplying the number of pixels by 255. The processor 470 may calculate average brightness of a plurality of images in which the driver 900 is detected.

The processor 470 may determine the calculated average brightness is smaller than a third set value (S1020). For example, average brightness of one image may be a value obtained by dividing the sum of brightness of all the pixels of the image by a value obtained by multiplying the number of pixels by 255. The third set value may be 0.9.

If the calculated average brightness is smaller than the third set value, the processor 470 may receive a level value of power provided to the light source 481 (S1030). The processor 470 may receive a level value of power, provided to the light source 481, from the light source 481.

The processor 470 may determine whether the received level value of power of the light source 481 is smaller than a fourth set value (S1040). A plurality of features may include that the processor 470 selects a plurality of images in which the driver 900 is detected among a plurality of images received from the camera 460 and calculates average brightness of the plurality of selected images. Furthermore, a plurality of features may include that the processor 470 selects a plurality of images in which the driver 900 is detected among a plurality of images received from the camera 460, calculates average brightness of the plurality of selected images, and receives a level of power supplied to the light source 481 if the calculated average brightness is smaller than the third set value. In this case, a condition may include whether the level of power supplied to the light source 481 is smaller than the fourth set value. If the level of power supplied to the light source 481 is smaller than the fourth set value, the processor 470 may determine an evaluation result of an image to be poor.

The processor 470 may display, on the display 180, that the level of power supplied to the light source 481 is low in a text or image form (S1050). Alternatively, the processor may output that the level of power supplied to the light source is low in a sound form. Alternatively, the processor 470 may output notification, indicating that the driver 900 should check a power connection of the light source 481. The meaning that the level of power is low may include a meaning that a voltage value supplied to the light source 481 is low or a current value supplied to the light source 481 is low. Alternatively, the processor 470 may turn on or display a warning light.

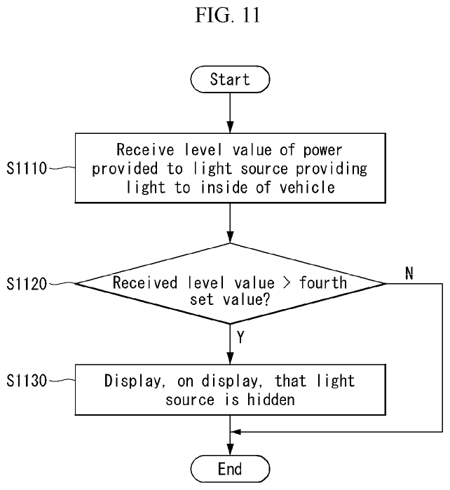

Referring to FIG. 11, the processor 470 may receive a level value of power supplied to the light source 481 (S1110). The processor 470 may select a plurality of images in which the driver 900 is detected among a plurality of images received from the camera 460, and may calculate average brightness of the plurality of selected images. If the calculated average brightness is smaller than a third set value, the processor may receive a level of power supplied to the light source 481.

The processor 470 may determine whether the received level value of power of the light source 481 is greater than a fourth set value (S1120). A plurality of features may include that the processor 470 selects a plurality of images in which the driver 900 is detected among a plurality of images received from the camera 460 and counts the number of a plurality of selected images. In this case, a condition may include a case where the number of plurality of selected images is smaller than a second set value, average brightness of the plurality of selected images is calculated, and the calculated average brightness is smaller than a third set value. If the calculated average brightness is smaller than the third set value, the processor 470 may determine an evaluation result of an image to be poor. If the evaluation result of the image is determined to be poor, the processor 470 may receive a level of power supplied to the light source 481. If the level of power supplied to the light source 481 is greater than the fourth set value, the processor 470 may display, on the display 180, that the light source 481 has been hidden in a text or image form (S1130). Alternatively, the processor may output that the light source 481 has been hidden in a sound form. Alternatively, the processor 470 may output notification, indicating that the driver 900 should remove an object that hides the light source 481. Alternatively, the processor 470 may turn on or display a warning light.

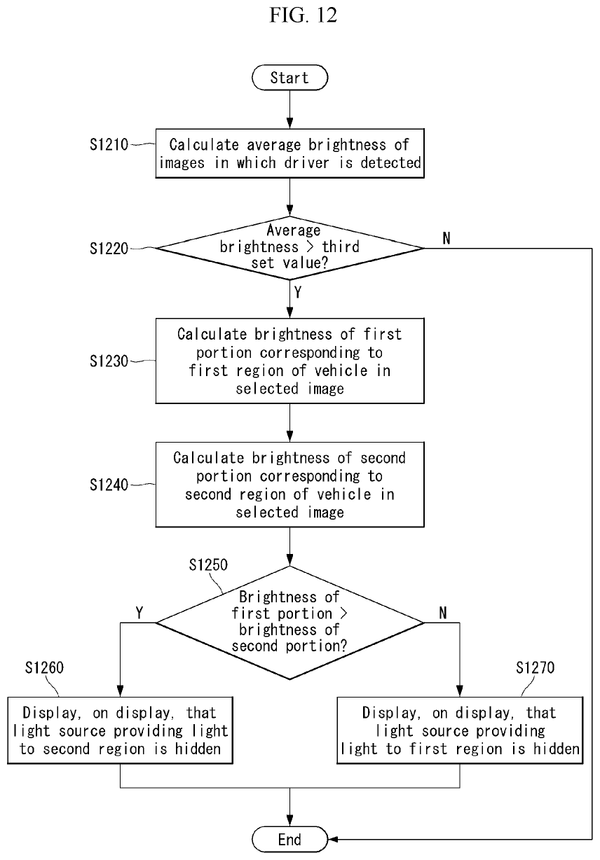

Referring to FIG. 12, the processor 470 may calculate average brightness of images in which the driver 900 is detected (S1210). The processor 470 may calculate average brightness of a plurality of images in which the driver 900 is detected.

The processor 470 may determine whether the calculated average brightness is greater than a third set value (S1220). A plurality of features may include that the processor 470 selects a plurality of images in which the driver 900 is detected among a plurality of images received from the camera 460 and counts the number of plurality of selected images. In this case, a condition may include a case where the number of plurality of selected images is smaller than a second set value, average brightness of the plurality of selected images is calculated, and the calculated average brightness is greater than the third set value. If the calculated average brightness is greater than the third set value, the processor 470 may determine an evaluation result of an image to be poor.

If the calculated average brightness is greater than the third set value, the processor 470 may calculate brightness of a first portion corresponding to the first region of the vehicle 700 in a selected image (S1230).

If the calculated average brightness is greater than the third set value, the processor 470 may calculate brightness of a second portion corresponding to the second region of the vehicle 700 in the selected image (S1240).

The processor 470 may determine whether the brightness of the first portion is greater than the brightness of the second portion (S1250).

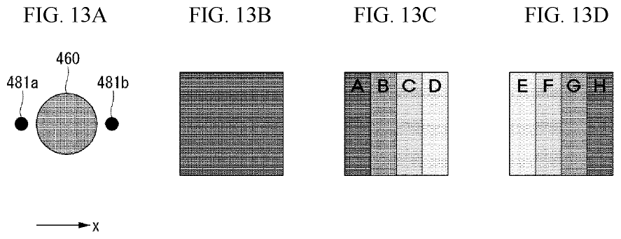

If the brightness of the first portion is greater than the brightness of the second portion, the processor 470 may display, on the display 180, that the light source 481 providing light to the second region has been hidden (S1260). Alternatively, the processor may output that a first light source 481a (refer to FIGS. 13A to 13D) has been hidden in a sound form. Alternatively, the processor 470 may output notification, indicating that the driver 900 should remove an object that hides the first light source 481a.

If the brightness of the second portion is greater than the brightness of the first portion, the processor 470 may display, on the display 180, that the light source 481 providing light to the first region has been hidden (S1270). Alternatively, the processor may output that a second light source 481b (refer to FIGS. 13A to 13D) has been hidden in a sound form. Alternatively, the processor 470 may output notification, indicating that the driver 900 should remove an object that hides the second light source 481b. Alternatively, the processor 470 may turn on or display a warning light.

Referring to FIG. 13A, the light source 481 may be formed plurally. The light source 481 may include the first light source 481a on the left of the camera 460 and the second light source 481b on the right of the camera 460.

Referring to FIG. 13B, if both the first light source 481a and the second light source 481b are poor or hidden, average brightness of images may be low.

Referring to FIG. 13C, the regions A and B of an image may correspond to portions to which the first light source 481a of the vehicle 700 supplies light. The regions C and D of the image may correspond to portions to which the second light source 481b of the vehicle 700 supplies light. If the regions A and B are dark and the regions C and D are bright, this may correspond to a case where the first light source 481a is poor or hidden or the second light source 481b operates normally.

Referring to FIG. 13D, the regions E and F of an image may correspond to portions to which the first light source 481a of the vehicle 700 provides light. The regions G and H of the image may correspond to portions to which the second light source 481b of the vehicle 700 provides light. If the regions G and H are dark and the regions E and F are bright, this may correspond to a case where the second light source 481b is poor or hidden and the first light source 481a operates normally.

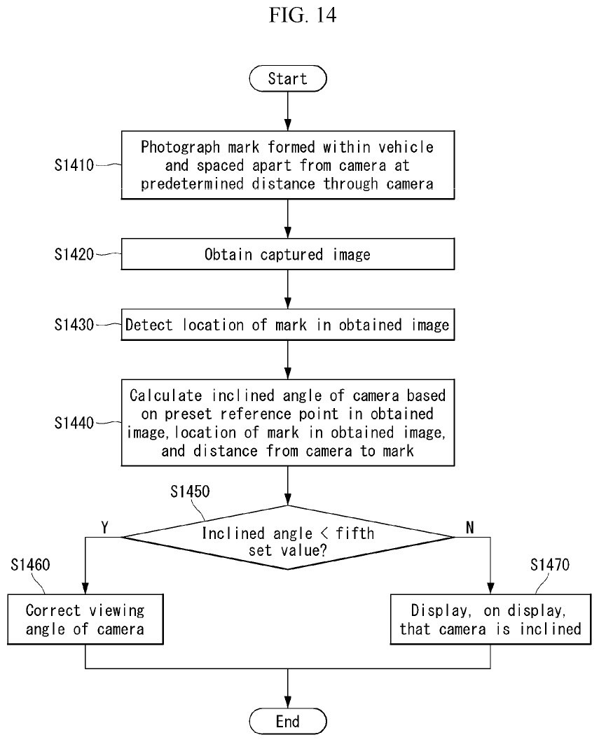

Referring to FIG. 14, the processor 470 may photograph a mark formed within the vehicle 700 and spaced apart from the camera 460 at a predetermined distance through the camera 460 (S1410). The mark may be formed within the indoor space of the vehicle 700. For example, the mark may be formed in a steering wheel, a driver's seat or around the driver's seat (S1410).

The processor 470 may obtain a captured image (S1420). The processor 470 may detect the location of the mark in the obtained image (S1430). The processor 470 may calculate an inclined angle of the camera 460 based on a preset reference point in the obtained image, the location of the mark in the obtained image, and the distance from the camera 460 to the mark (S1440).

The processor 470 may determine whether the inclined angle is smaller than a fifth set value (S1450). For example, the fifth set value may be 5°. A plurality of features may include an angle value that the camera 460 has been inclined. In this case, a condition may include a case where the inclined angle of the camera 460 is the fifth set value or more. If the inclined angle of the camera 460 is the fifth set value or more, the processor 470 may determine an evaluation result of an image to be poor.

If the inclined angle of the camera 460 is smaller than the fifth set value, the processor 470 may correct the focus or viewing angle of the camera 460 (S1460). Alternatively, if the inclined angle of the camera 460 is smaller than the fifth set value, the processor 470 may calibrate the camera 460. Alternatively, if the driver 900 experiences an abnormal operation while using an app associated with the vehicle control device 400, the driver may request, input or instruct the camera 460 to perform calibration.

If the inclined angle of the camera 460 is the fifth set value or more, the processor 470 may display, on the display 180, that the camera 460 has been inclined (S1470). Alternatively, the processor may output that the camera 460 has been inclined in a sound form. Alternatively, the processor 470 may turn on or display a warning light.

A vehicle control device according to at least one embodiment of the present invention is a vehicle control device detecting a malfunction of a camera photographing a driver of a vehicle. The method includes an interface unit connected to a display and a camera within a vehicle, a processor configured to receive an image obtained by the camera through the interface unit and to evaluate the received image based on a plurality of features, wherein the processor evaluates the image depending on whether the plurality of features satisfies a condition in which a driver sitting in the vehicle is recognizable, and a memory storing malfunction information of the camera corresponding to an evaluation result of the image. The processor may be configured to control the display to display malfunction information of the camera if the evaluation result of the image is determined to be poor.

The processor may be configured to control the display to display that a level of power supplied to the camera is low if an image is not received through the interface unit.

The camera may obtain one image for each exposure signal. The processor may be configured to transmit a plurality of exposure signals, corresponding to a first set value, to the camera during a unit time, and control the display to display that an exposure operation of the camera is poor if a number of images obtained from the camera during the unit time is smaller than the first set value.

The camera may photograph at least some of the body of the driver sitting in the vehicle and may include a light source providing light to the driver. The processor may be configured to select an image in which the driver is detected among a plurality of images obtained from the camera during the unit time and to control the display to display that the light source is poor if the number of selected images is smaller than a second set value.

The processor may be configured to calculate average brightness of the selected image, receive a level value of power supplied to the light source through the interface unit if the calculated average brightness is smaller than a third set value, and control the display to display that the level of the power supplied to the light source is low if the level value of the power is smaller than a fourth set value.

The processor may be configured to control the display to display that the light source of the camera is hidden if the level value of the power is greater than the fourth set value.

A plurality of the light sources may be disposed. The processor may be configured to calculate the average brightness of the selected image and to control the display to display that at least some of the plurality of light sources is hidden if the calculated average brightness is greater than a third set value.

The plurality of light sources may include a first light source provided on a first side of the camera to provide light to a first region and a second light source spaced apart from the first light source and provided on a second side of the camera to provide light to a second region. The processor may be configured to control the display to display that the second light source is hidden if the average brightness of the selected image is the third set value or more and brightness of a portion corresponding to the first region in the selected image is higher than brightness of a portion corresponding to the second region.

The camera may photograph a mark formed within the vehicle and spaced from the camera. The processor may be configured to detect a location of the mark in the image obtained by the camera, calculate an inclined angle of the camera based on the location of the mark detected in the image and the distance between the camera and the mark, and correct a viewing angle of the camera if the inclined angle is smaller than a fifth set value.

The mark may be formed in the steering wheel of the vehicle.

The processor may be configured to control the display to display that the camera is inclined if the inclined angle is the fifth set value or more.

A method of controlling a vehicle according to another embodiment of the present invention is a method of controlling a vehicle detecting a malfunction of a camera photographing a driver of a vehicle. The method may include evaluating an image obtained by the camera based on a plurality of features, wherein the image is evaluated depending on whether the plurality of features satisfies a condition in which a driver sitting in a vehicle is recognizable, determining a malfunction of the camera based on an evaluation result of the image, selecting malfunction information matched up with the evaluation result of the image if the evaluation result of the image is determined to be poor, and outputting the selected malfunction information.

The method may further include displaying, on a display positioned within the vehicle, that a level of power supplied to the camera is low if an image is not obtained by the camera.

The camera may obtain one image for each exposure signal. The method may further include transmitting, to the camera, a plurality of exposure signals corresponding to a first set value during a unit time and displaying, on the display positioned within the vehicle, that an exposure operation of the camera is poor if the number of images obtained from the camera during the unit time is smaller than the first set value.

The method may further include providing light to the driver of the vehicle through a light source positioned within the vehicle, photographing at least some of the body of the driver through the camera, selecting an image in which the driver is detected among a plurality of images obtained from the camera during the unit time, and displaying, on the display positioned within the vehicle, that the light source is poor if the number of selected images is smaller than the second set value.

The method may further include calculating average brightness of the selected image if the number of selected images is smaller than the second set value, receiving a level value of power supplied to the camera if the calculated average brightness is smaller than a third set value, and displaying, on the display positioned within the vehicle, that the level of the power supplied to the camera is low if the level value of power is smaller than a fourth set value.

The method may further include displaying, on the display positioned within the vehicle, that the light source of the camera is hidden if the level value of the power is greater than the fourth set value or.

A plurality of the light sources may be disposed. The method may further include displaying, on the display positioned within the vehicle, that at least some of the plurality of light sources is hidden if the average brightness of the selected images is a third set value or more.

The method may further include photographing a mark formed within the vehicle and spaced apart from the camera at a predetermined distance through the camera, detecting a location of the mark in the image obtained by the camera and calculating an inclined angle of the camera based on the location of the mark detected in the image and the predetermined distance, and correcting a viewing angle of the camera if the inclined angle is smaller than a fifth set value.

The method may further include displaying, on the display positioned within the vehicle, that the camera is inclined if the inclined angle is the fifth set value or more.

According to at least one of the embodiments of the present invention, there can be provided the vehicle control device for verifying the initial state of the camera after the engine of the vehicle is started.

According to at least one of the embodiments of the present invention, there can be provided the vehicle control device for verifying the state of the camera while the vehicle is driving.

According to at least one of the embodiments of the present invention, there can be provided the vehicle control device for outputting malfunction information when a malfunction of the camera is detected.

The vehicle control device according to the foregoing exemplary embodiment may enhance passengers' convenience. The vehicle control device according to the foregoing exemplary embodiment may be used during autonomous driving or semi-autonomous driving of a vehicle.

The features, structures, and effects described in the above embodiments are included in at least one embodiment of the present invention, and are not necessarily limited to only one embodiment. Moreover, the features, structures, and effects described in the embodiments may also be combined or modified to be carried out in other embodiments by those skilled in the art to which the embodiments pertain. Thus, the contents related to the combination and modification shall be construed to be included in the scope of the present invention.

Further, although the embodiments have been mainly described until now, they are just exemplary and do not limit the present invention. Thus, those skilled in the art to which the present invention pertains will know that various modifications and applications which have not been exemplified may be carried out within a range which does not deviate from the essential characteristics of the embodiments. For example, the constituent elements described in detail in the exemplary embodiments can be modified to be carried out. Further, the differences related to such modifications and applications shall be construed to be included in the scope of the present invention specified in the attached claims.

1. A vehicle control device detecting a malfunction of a camera photographing a driver of a vehicle, the vehicle control device comprising:
an interface unit connected to a display and a camera within a vehicle;
a processor configured to receive an image obtained by the camera through the interface unit and to evaluate the received image based on a plurality of features, wherein the processor evaluates the image depending on whether the plurality of features satisfies a condition in which a driver sitting in the vehicle is recognizable; and
a memory storing malfunction information of the camera corresponding to an evaluation result of the image,
wherein the processor is configured to control the display to display malfunction information of the camera if the evaluation result of the image is determined to be poor.

2. The vehicle control device of claim 1,
wherein the processor is configured to control the display to display that a level of power supplied to the camera is low if an image is not received through the interface unit.

3. The vehicle control device of claim 1,
wherein the camera obtains one image for each exposure signal, and
wherein the processor is configured to:
transmit a plurality of exposure signals, corresponding to a first set value, to the camera during a unit time, and
control the display to display that an exposure operation of the camera is poor if a number of images obtained from the camera during the unit time is smaller than the first set value.

4. The vehicle control device of claim 1,
wherein the camera photographs at least some of a body of the driver sitting in the vehicle and comprises a light source providing light to the driver, and
wherein the processor is configured to:
select an image in which the driver is detected among a plurality of images obtained from the camera during the unit time, and
control the display to display that the light source is poor if a number of selected images is smaller than a second set value.

5. The vehicle control device of claim 4,
wherein the processor is configured to:
calculate average brightness of the selected image,
receive a level value of power supplied to the light source through the interface unit if the calculated average brightness is smaller than a third set value, and
control the display to display that the level of the power supplied to the light source is low if the level value of the power is smaller than a fourth set value.

6. The vehicle control device of claim 5,
wherein the processor is configured to control the display to display that the light source of the camera is hidden if the level value of the power is greater than the fourth set value.

7. The vehicle control device of claim 4,
wherein a plurality of the light sources is disposed, and
wherein the processor is configured to:
calculate the average brightness of the selected image, and
control the display to display that at least some of the plurality of light sources is hidden if the calculated average brightness is greater than a third set value.

8. The vehicle control device of claim 7,
wherein the plurality of light sources comprises:
a first light source provided on a first side of the camera to provide light to a first region; and
a second light source spaced apart from the first light source and provided on a second side of the camera to provide light to a second region,
wherein the processor is configured to control the display to display that the second light source is hidden if the average brightness of the selected image is the third set value or more and brightness of a portion corresponding to the first region in the selected image is higher than brightness of a portion corresponding to the second region.

9. The vehicle control device of claim 1,
wherein the camera photographs a mark formed within the vehicle and spaced from the camera, and
wherein the processor is configured to:
detect a location of the mark in the image obtained by the camera,
calculate an inclined angle of the camera based on the location of the mark detected in the image and a distance between the camera and the mark, and
correct a viewing angle of the camera if the inclined angle is smaller than a fifth set value.

10. The vehicle control device of claim 9,
wherein the mark is formed in a steering wheel of the vehicle.

11. The vehicle control device of claim 9,
wherein the processor is configured to control the display to display that the camera is inclined if the inclined angle is the fifth set value or more.

12. A method of controlling a vehicle detecting a malfunction of a camera photographing a driver of a vehicle, the method comprising:
evaluating an image obtained by the camera based on a plurality of features, wherein the image is evaluated depending on whether the plurality of features satisfies a condition in which a driver sitting in a vehicle is recognizable;
determining a malfunction of the camera based on an evaluation result of the image;
selecting malfunction information matched up with the evaluation result of the image if the evaluation result of the image is determined to be poor; and
outputting the selected malfunction information.

13. The method of claim 12, further comprising:
displaying, on a display positioned within the vehicle, that a level of power supplied to the camera is low if an image is not obtained by the camera.

14. The method of claim 12,
wherein the camera obtains one image for each exposure signal, and
wherein the method further comprises:
transmitting, to the camera, a plurality of exposure signals corresponding to a first set value during a unit time, and
displaying, on the display positioned within the vehicle, that an exposure operation of the camera is poor if a number of images obtained from the camera during the unit time is smaller than the first set value.

15. The method of claim 12, further comprising:
providing light to the driver of the vehicle through a light source positioned within the vehicle;
photographing at least some of a body of the driver through the camera;
selecting an image in which the driver is detected among a plurality of images obtained from the camera during the unit time; and
displaying, on the display positioned within the vehicle, that the light source is poor if a number of selected images is smaller than the second set value.

16. The method of claim 15, further comprising:
calculating average brightness of the selected image if the number of selected images is smaller than the second set value;
receiving a level value of power supplied to the camera if the calculated average brightness is smaller than a third set value; and
displaying, on the display positioned within the vehicle, that the level of the power supplied to the camera is low if the level value of power is smaller than a fourth set value.

17. The method of claim 16, further comprising:
displaying, on the display positioned within the vehicle, that the light source of the camera is hidden if the level value of the power is greater than the fourth set value.

18. The method of claim 15,
wherein a plurality of the light sources is disposed, and
wherein the method further comprises displaying, on the display positioned within the vehicle, that at least some of the plurality of light sources is hidden if the average brightness of the selected images is a third set value or more.

19. The method of claim 12, further comprising:
photographing a mark formed within the vehicle and spaced apart from the camera at a predetermined distance through the camera;
detecting a location of the mark in the image obtained by the camera and calculating an inclined angle of the camera based on the location of the mark detected in the image and the predetermined distance; and
correcting a viewing angle of the camera if the inclined angle is smaller than a fifth set value.

20. The method of claim 19, further comprising:
displaying, on the display positioned within the vehicle, that the camera is inclined if the inclined angle is the fifth set value or more.
